(19) United States
(12) Patent Application Publication
(10) Pub. No.: US 2022/0290486 A1
(43) Pub. Date: Sep. 15, 2022

(54) Microjamb window & door jamb system

(71) Applicant: Paul John Colletti, N. Richmond, WI (US)

(72) Inventor: Paul John Colletti, N. Richmond, WI (US)

(21) Appl. No.: 17/300,121

(22) Filed: Mar. 15, 2021

(51) Int. Cl. E06B 1/06; E06B 1/16; E06B 1/28

(52) U.S. Cl. CPC E06B 1/06; E06B 1/16; E06B 1/28

(57) ABSTRACT

The primary object of the MicroJamb Window & Door Jamb System is to provide an improved, yet, less costly jamb that, along with a system of interchangeable parts, simplifies the production and installation of windows and doors (so as to substantially reduce the time, materials and costs involved in both) and which, by design, makes windows and doors much more weather-tight. It accomplishes this by: reducing the width of the standard 4½-inch jamb by 1 inch (which immediately reduces material costs 22%) so as to fit between the drywall and sheathing of exterior walls; replacing wood molding with simulated molding of extruded plastic (reducing molding costs by over 50%); and by eliminating interior trim, when desired, altogether (reducing cost of interior trim 100%).

MicroJambs come in 2 types: a “solid” type made of solid wood, micro-plywood or a composite; and a “hollow” type made either of extruded plastic or aluminum. Both types employ the same MicroJamb “system” consisting of parts that all attach to the MicroJamb quickly, and without the use of tools, via its unique, built-in, “strike, latch and stop” device. {In FIG. 3 it is that part of jamb “a” into which the male part of “d” (shown partially inserted) mates perfectly when fully inserted}

Said parts come in 4 categories:
1. Hollow Simulated Trim (MicroTrim) in a variety. of styles, both interior and exterior, made of extruded plastic.
2. “Trimless” Drywall Beads: one to eliminate all window and door trim (MicroTrimless) and made of extruded plastic {FIG. 3, part “d”}; the other to eliminate all base molding (MicroTrimlessBaseBead) made of either extruded plastic or aluminum. {FIG. 6 part “a”}
3. Stops, both interior and exterior, made of solid wood {FIG. 5, part “b”}, composites, extruded plastic and aluminum {FIG. 7, part “d”} and compliant materials such as Nylon and Neoprene.
4. Sill & Saddle Ramps {FIG. 7 parts “b” and “e”} are parts attached to the jamb to form sills and saddles where and when conditions exist that will not permit the use of “flared” trim to serve as the ramps.
5. A Combination FlaredTrim/Sill & Saddle Ramp
{FIG. 8 part “a”}
6. Base Plugs: one to hide the gap between the finished flooring and wall (MicroBasePlug) {FIG. 6, part “g”}; the other (MicroBaseBumper) to hide the same gap but also to prevent the base of the drywall from being damaged by vacuum cleaner nozzels, chair legs, etc. {FIG. 8, part “a”}

All parts are attached to and detached from the MicroJamb via its unique, built-in, “strike, latch and stop” except for the MicroTrimlessBaseBead {FIG. 6 part “a”} which attaches to the sole plate of a wood-frame partition or wall, instead, without fasteners.

Other objects of the MicroJamb System are to:
A. Eliminate the need for exterior caulking;
B. Eliminate the need for drip caps;
C. Eliminate the need to paint windows and doors;
D. Reduce the cost of storing and transporting windows and doors (via their reduced size);
E. Enable window and door trim to be installed quickly and easily, pre-cut, pre-mitred and without tools;
F. Enable window and door jambs to be anchored with hidden fasteners {FIG. 3, part “g”};
G. Enable the use of inexpensive exposed door hinges, when desired {FIG. 5, part “d”};
H. Provide an improved seal against air and water infiltration by virtue of its 1-inch reduced width which enables MicroJambs to fit tightly between the drywall of wood-frame partitions {FIG. 3}, and between the drywall and sheathing of wood-frame exterior walls {FIG. 2}, whereas standard jambs invite air and water Infiltration (especially through exterior head jambs which, consequently, require drip caps).
{FIG. 1, part “e”}

### DRAWINGS

FIG. 1, for comparison only, depicts a standard 5/4″×4½″ wood, window or door jamb {a} in an exterior wood-frame wall with interior wood trim {g} and exterior wood trim {f} and a standard drip cap {e}. Also shown is a double header {b}, plywood header filler {i}, sheathing {c}, siding {d}, and drywall {h}.

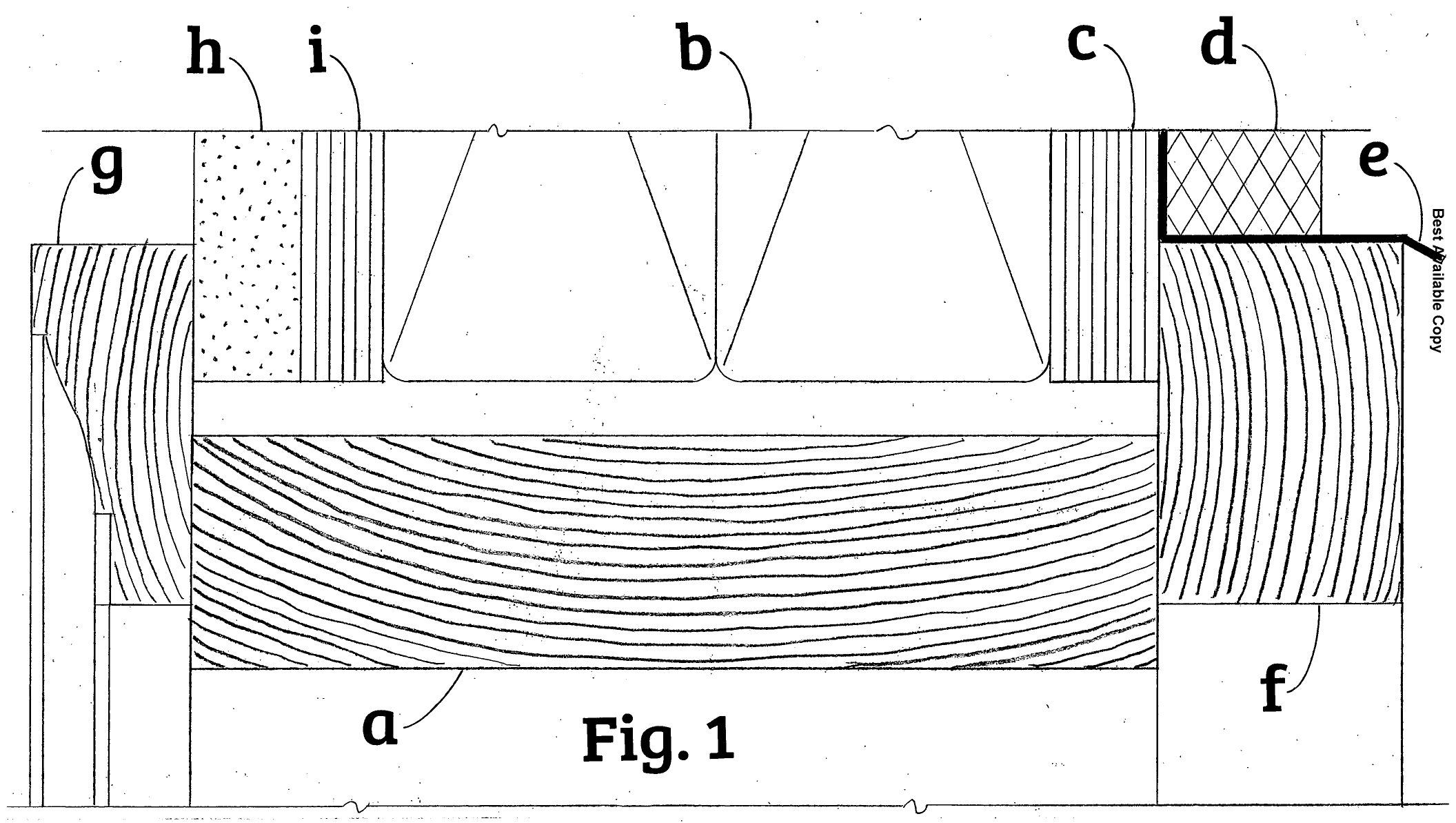

FIG. 2, in comparison, depicts a 5/4″×3½″ solid wood, window or door MicroJamb {a} in an exterior wood-frame wall with a MicroTrimless Drywall Bead {b} and (typical) Micro Exterior Trim {d}. Also shown is the drywall {c}. Note that no drip cap is needed. Also note that recesses in the front and rear edges of the MicroJamb enable it to be anchored (where necessary) with concealed fasteners (preferably screws) not shown.

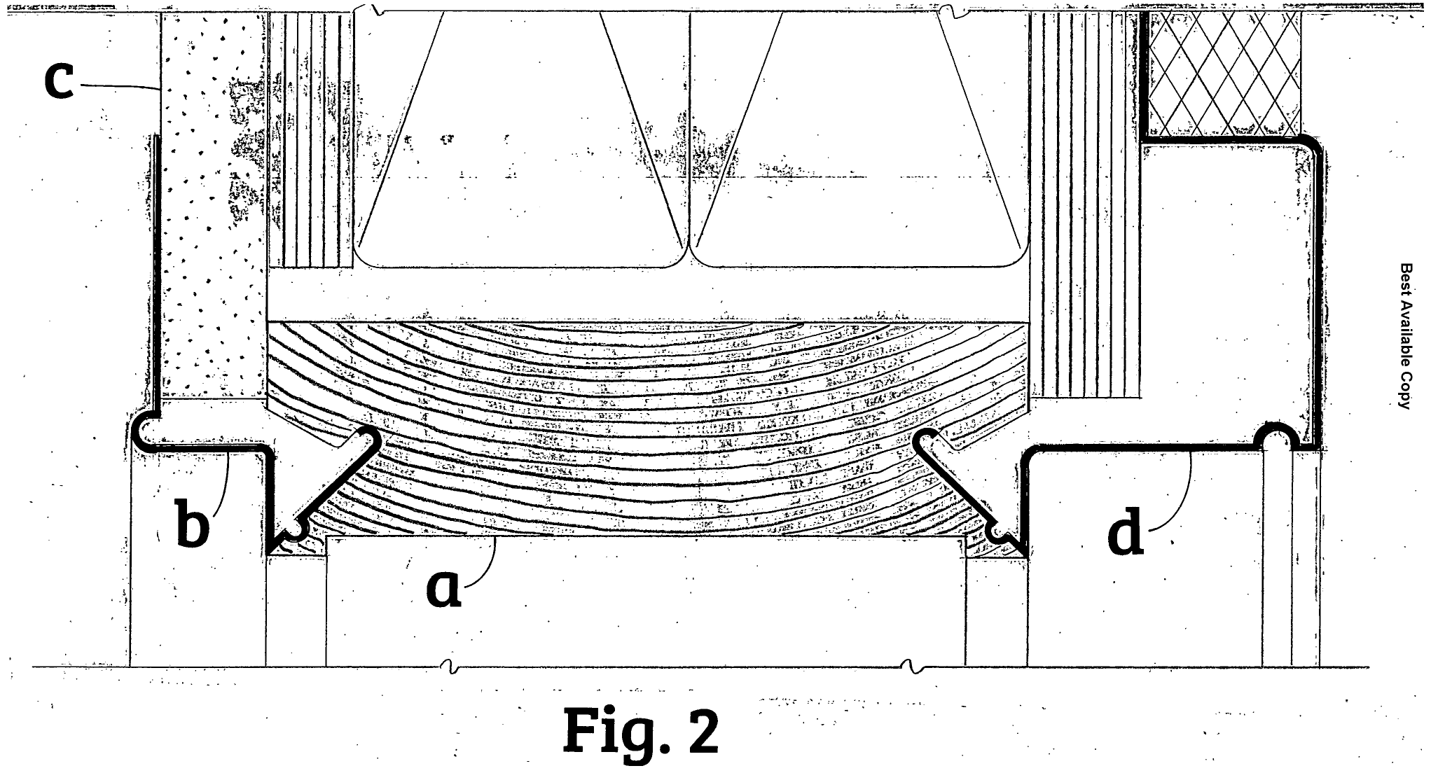

FIG. 3 depicts a 5/4″×3½″ extruded plastic or aluminum MicroJamb {a} in an interior wood-frame partition, with a plastic MicroTrimlessDrywallBead {d} which is about to be installed via the built-in “strike, latch and stop”. Also shown are drywall {b}, jack stud {c}, screw port {e} (to attach jambs to each other), plastic U-shims {f} and anchoring wood screw {g}.

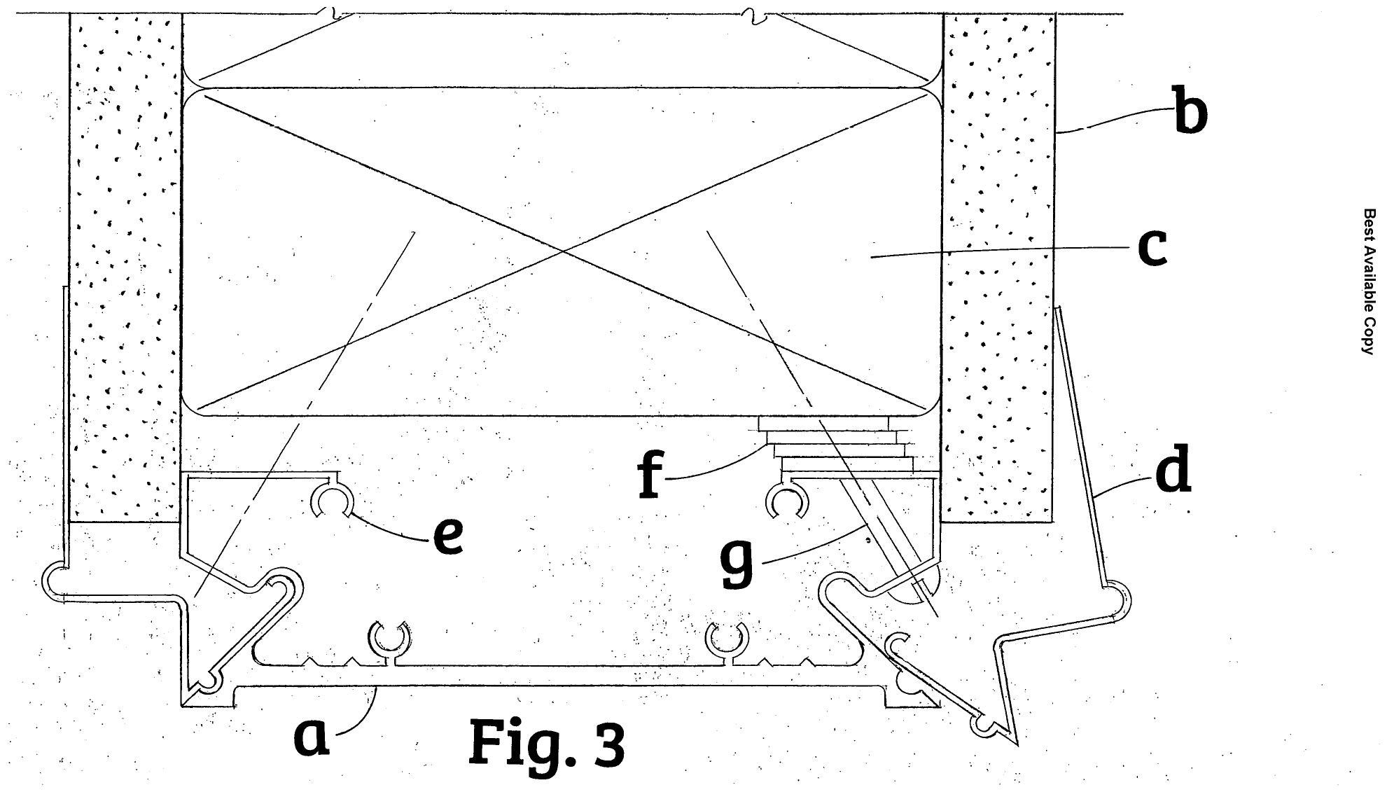

FIG. 4 depicts a 5/4″×3½″ reversible plastic or aluminum, window or door, MicroJamb to accommodate different size windows and doors.

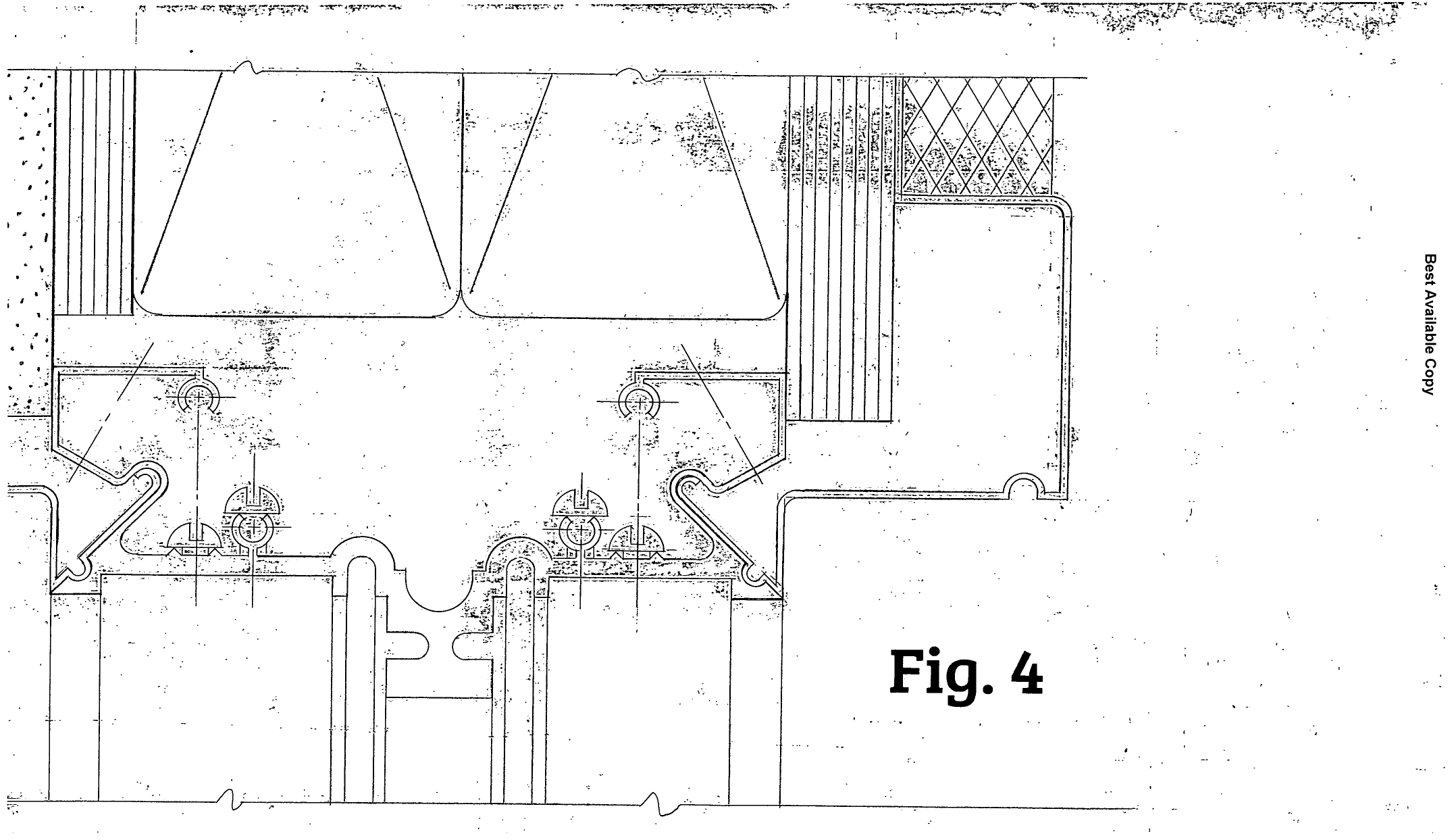

FIG. 5 depicts a 5/4″×3½″ micro-laminated wood, interior door MicroJamb {a} with a wood door stop {b}, wood door {c}, door hinge {d} and jack stud {e}.

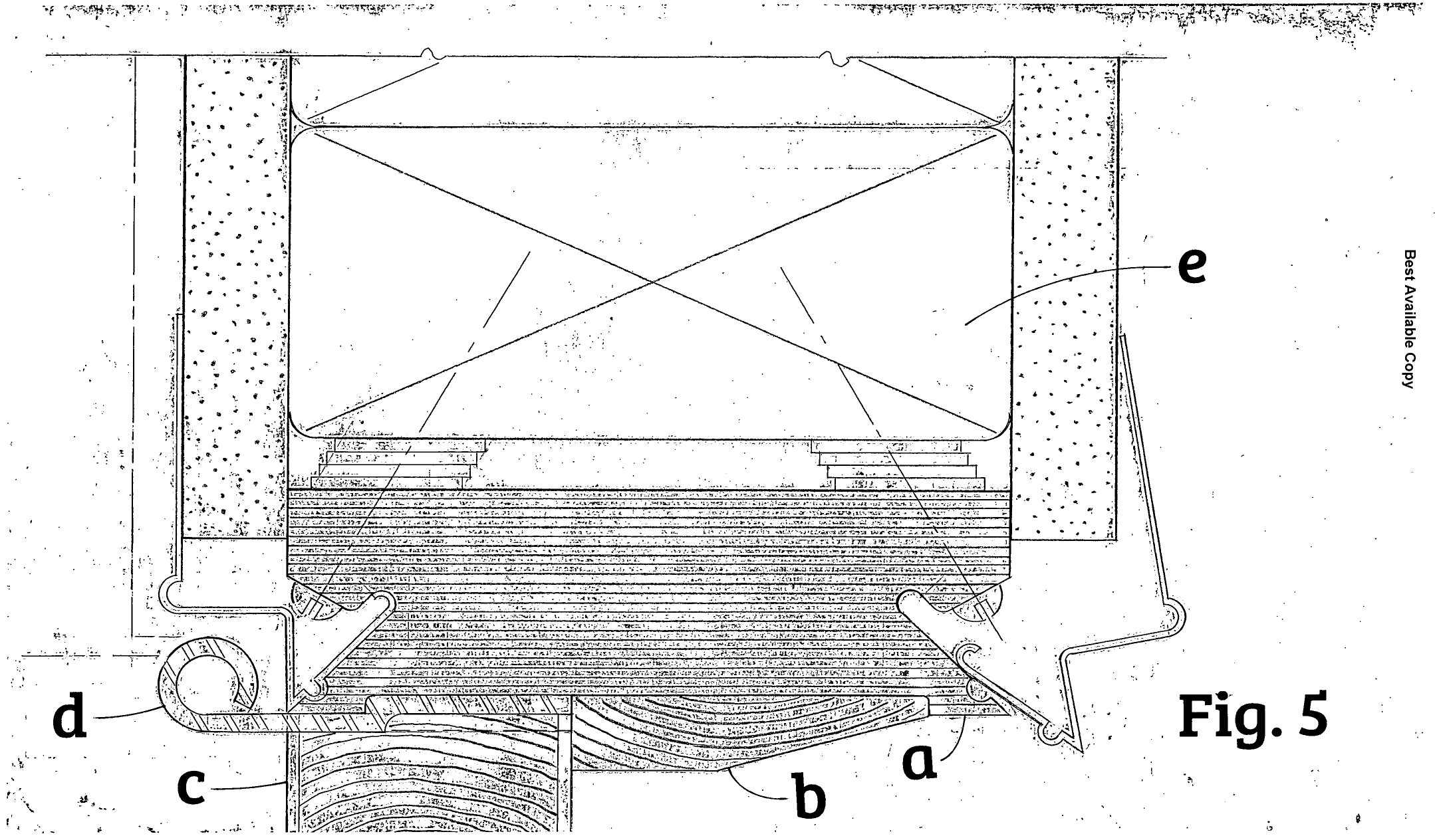

FIG. 6 depicts the MicroTrimlessDrywallBaseBead {a} which when combined with the use of the MicroTrimless DrywallBead (surrounding windows and doors) {FIG. 2, part “b”} enables interior walls to be completely trimless. An optional U-shaped MicroBasePlug {g} is used to conceal the gap which often exists between the finish floor and the wall. An optional J-shaped MicroBasePlugBumper {FIG. 9, part “a”} extends beyond the drywall to act as a (resilient) bumper to protect the drywall along its entire base. Also shown is subflooring {c}, finished floor {b}, sole plate {d}, wall stud {e}, & drywall {f}.

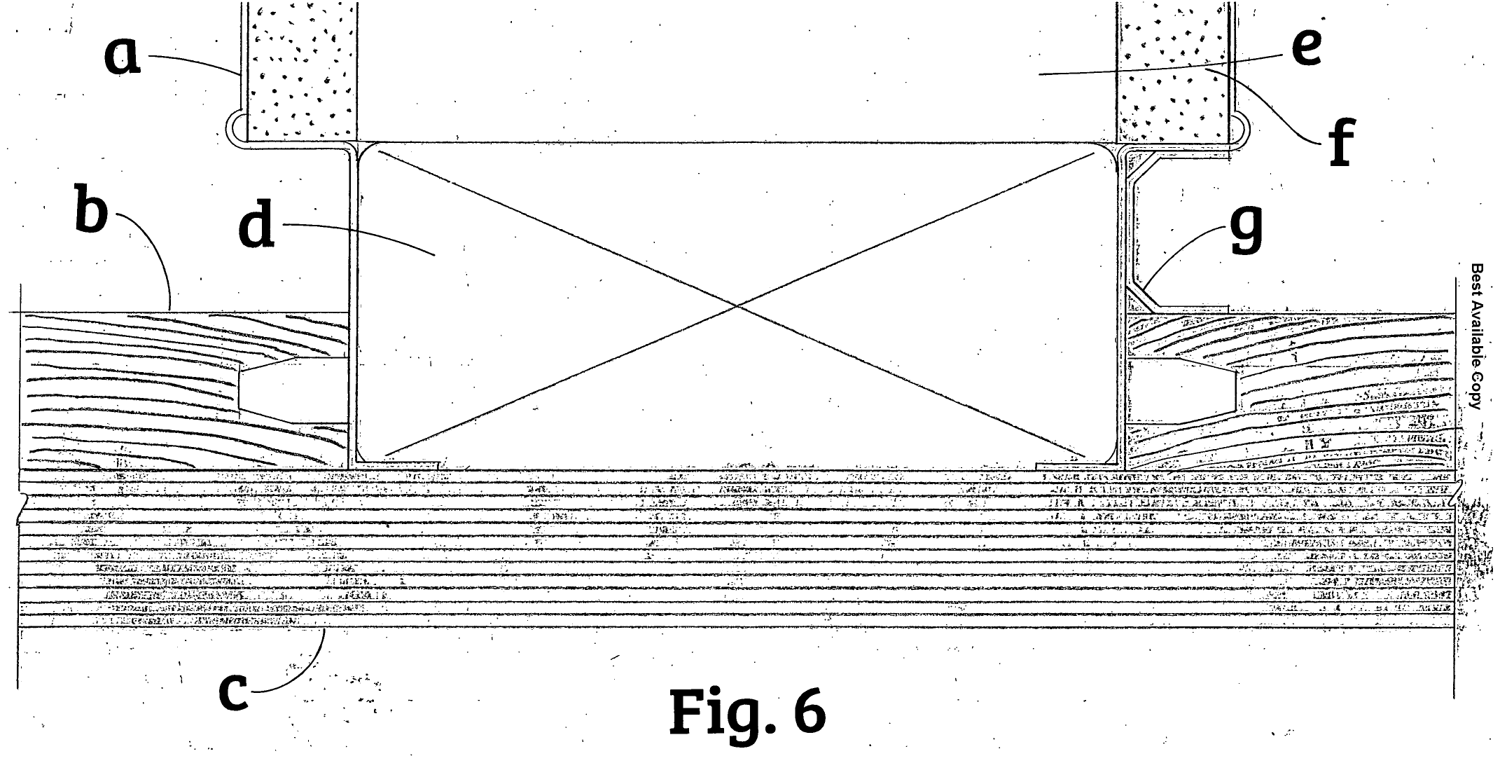

FIG. 7 depicts a 5/4″×3½″ extruded plastic or aluminum MicroJamb {a}. When combined with the (optional) Interior Saddle Ramp {b}, ExteriorSaddleRamp {e} and Door/WindowStop {d}, it becomes an exterior door saddle. Minus the InteriorSaddleRamp {b}, it becomes a window sill.

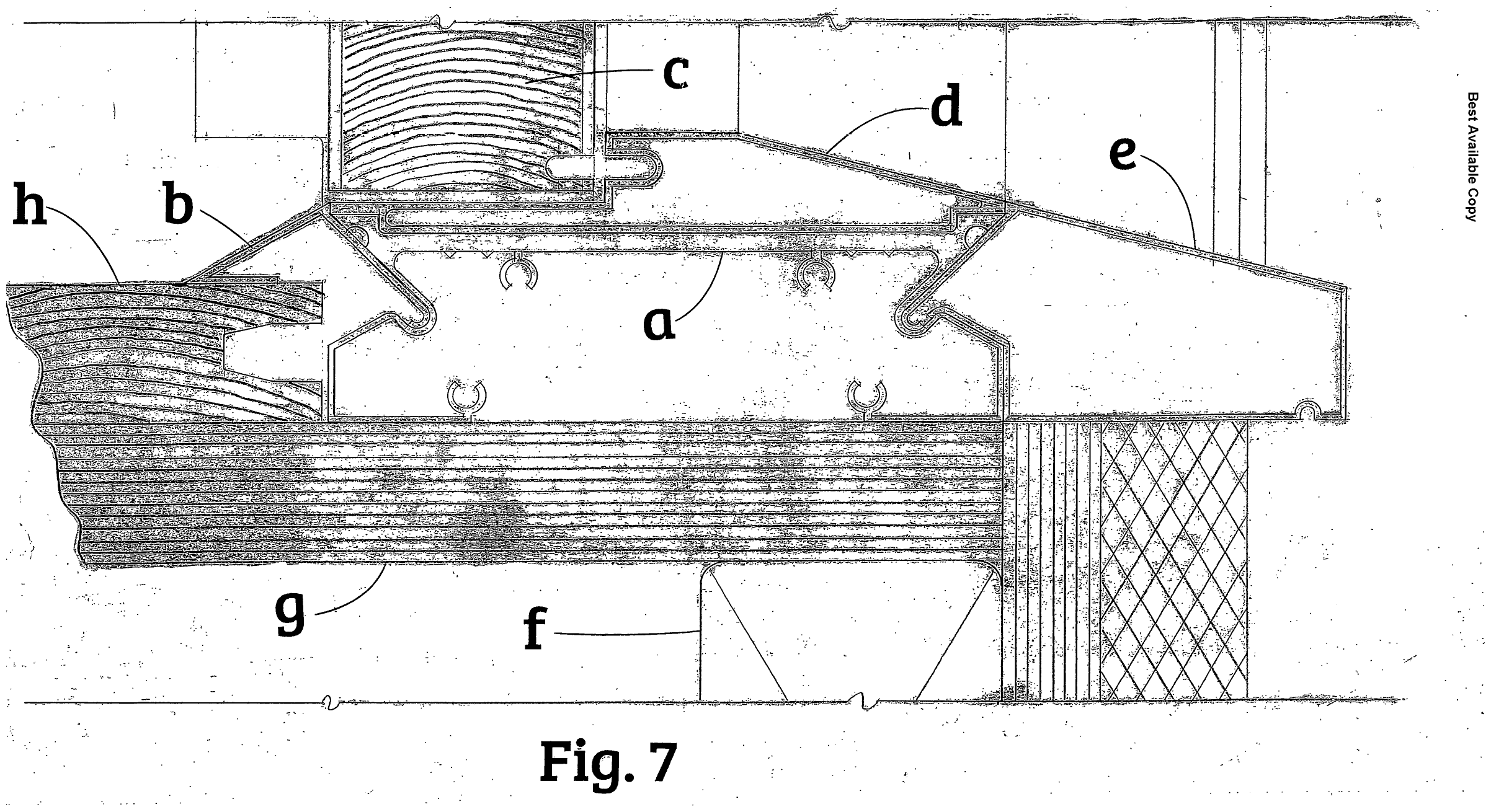

FIG. 8 {part “a”} depicts FlaredExteriorMicroTrim (used as an alternative to the ExteriorSaddleRamp used in FIG. 7, part “e”). FlaredMicroTrim serves both as exterior trim and as a Sill or Saddle Ramp. The 1:12 flare creates a 1:12 pitch to aid water-shedding when installed horizontally at the head and sill of windows and at the head and saddle of doors. And, as is true of all ExteriorMicroTrim, it has a flange to prevent air and water infiltration.

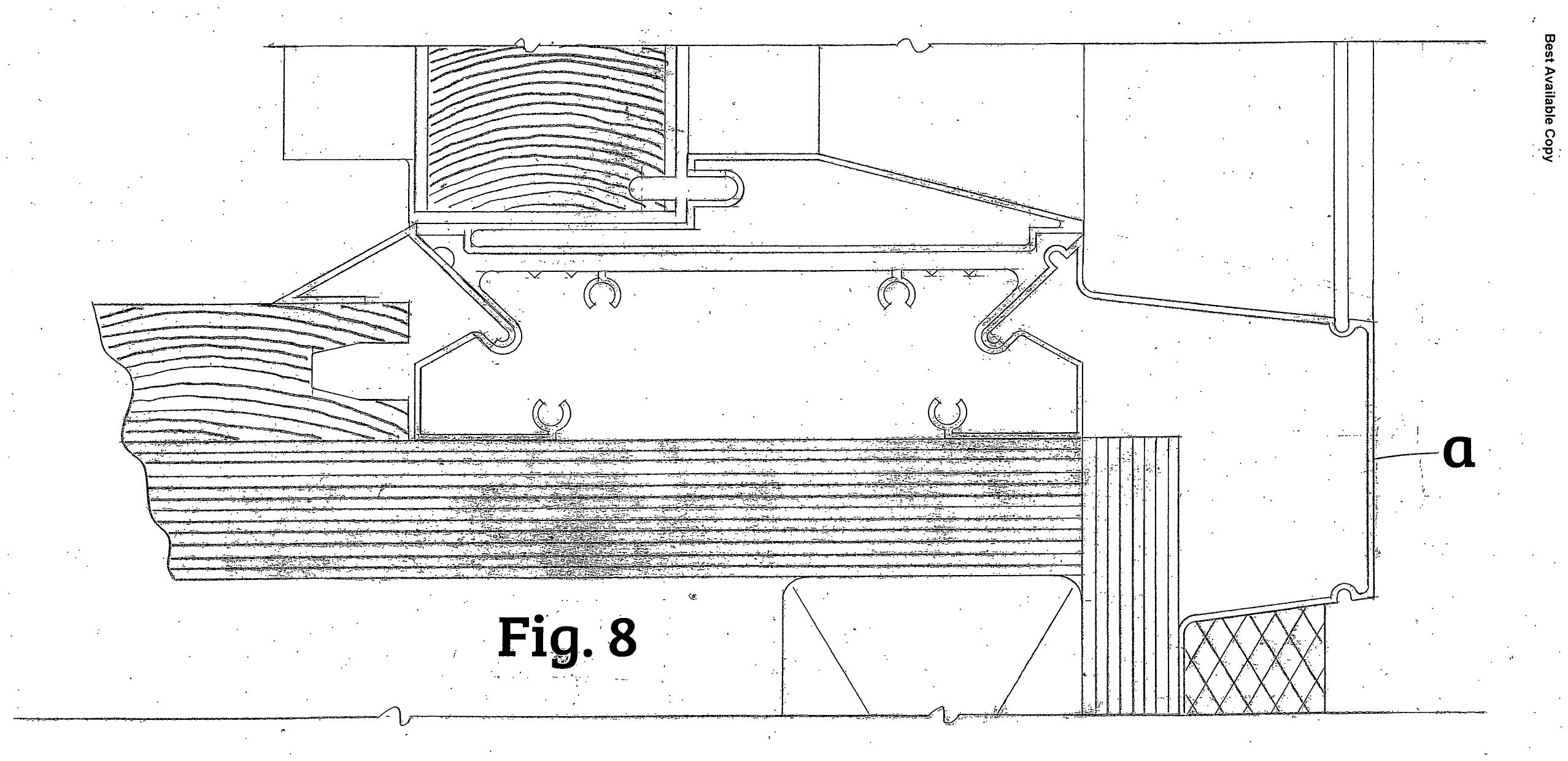

FIG. 9, {Part “a”} depicts the MicroBasePlugBumper.

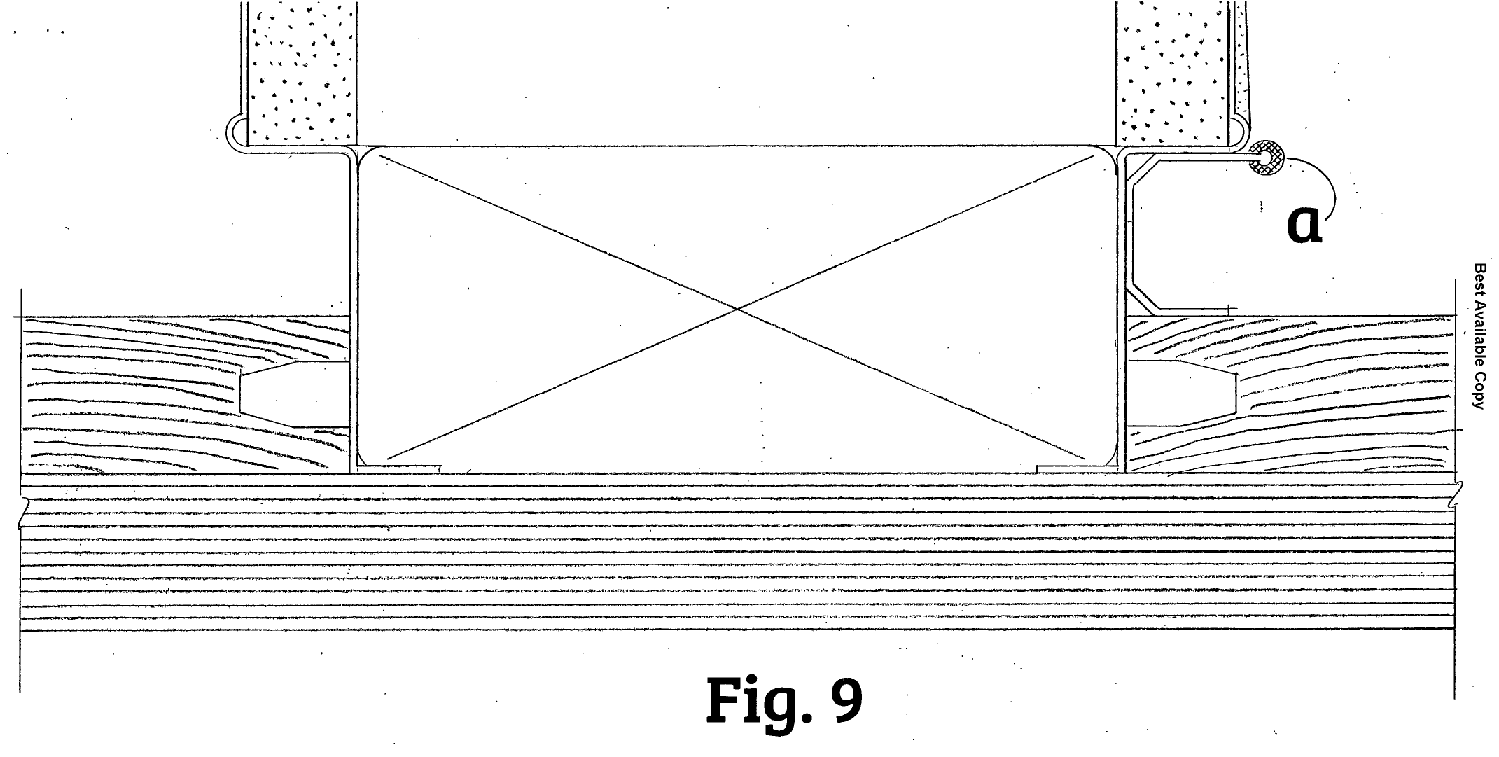

1. A solid or hollow window and door jamb that, by virtue of its 1-inch reduced width, fits tightly between the drywall of interior wood-frame partitions, and between the sheathing and drywall of exterior wood-frame walls, having: a continuous (preferably) 75-degree, V-shaped notch in its front and rear edges, said notches beginning at each exposed corner, one side of each notch forming a recessed surface at 30-degrees to its rear surface through which screws (or equal) can be driven to anchor the jamb to the jack studs, the other side of the notch (running at 45 degrees to both the front and sides of the jamb) having a “(flat) strike, (half-circular) latch and (half-circular) stop” to enable a variety of parts (such as interior and exterior plastic simulated trim, plastic drywall beads and sill and saddle ramps) to be attached to and detached from the jamb without the use of tools, said parts able to be both mitred and have a continuous reveal by virtue of their attachment at 45 degrees to the corners of the jamb; and, preferably, a continuous, shallow rabbet centered in its face to, both, help retain window and door stops and to conceal their, otherwise, exposed edges.

2. A combination Reveal/Drywall Corner Bead in the shape of a modified W that is preferably made of a slightly compliant extruded plastic (to aid in its removal by pressing it away and out of its half-circular latch), the exposed innermost side forming a reveal, preferably finished to match the finish of the jamb, the exposed outermost side forming a finished or unfinished, preferably perforated, drywall corner bead, said combination Reveal/Drywall Corner Bead able to be attached and detached from a MicroJamb via its integrated “strike, latch and stop” system without the use of tools, the interior male end of which mates perfectly with said female strike, (half-circular) latch and (half-circular) stop. When the bead is, both, finished and unperforated, it can be either left as is (appearing as mini-trim) or painted to match the wall.

3. Hollow exterior trim of slightly compliant extruded plastic that take the profiles of standard wood trim, has a reveal, and attaches and detaches from a MicroJamb via its integral “strike, latch and stop”, the interior male end mating perfectly with said female strike, latch and stop, that has a continuous flange on its outermost exposed side, and a continuous drip groove on the innermost exposed side that extends either perpendicularly or “flared” at a slight angle (1:12) from the wall when installed, the latter to aid the shedding of water when installed horizontally to serve, also, as a sill or saddle ramp.
